(19) United States
(12) Patent Application Publication
(10) Pub. No.: US 2006/0184881 A1
(43) Pub. Date: Aug. 17, 2006

(54) Content-producing device, output device and computer-readable medium

(75) Inventors: Junichi Yokoyama, Saitama-shi (JP); Naoki Yamaguchi, Saitama-shi (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/356,079

(22) Filed: Feb. 17, 2006

(30) Foreign Application Priority Data
Feb. 17, 2005 (JP) P.2005-040865

(51) Int. Cl. G06F 17/00; G06F 17/21; G06F 17/30

(52) U.S. Cl. 715/731; 715/500.1; 707/1

(57) ABSTRACT

A tool capable of easily producing a presentation content based on image exhibition is provided. The system allowed for making a presentation while taking an image of a material put on a material base of a material-presenting device by an imager device and projecting the image onto a screen. The real-time data of an image projected to the screen during presentation and the real-time data of a voice explanation are recorded, as presentation content data, in a content-producing device. The presentation is again reproduced as it is while reproducing the present-content data as primary data. On this occasion, by operating the material-presenting device in proper timing, the content is edited. By repeating the editing together with re-playing the presentation, a quality presentation content can be easily produced.

### FIELD OF THE INVENTION

The present invention relates to an art to make a presentation or an education by use of an image.

### BACKGROUND OF THE INVENTION

There is known a technique to conduct a presentation by projecting the material of a figure, a table, etc. while pointing at it. This technique is frequently used in conference explanations.

As the hardware for use in the presentation using an image, there are known those of descriptions, say, in Japanese Patent No. 3,201,707 and JP-A-2000-341588 etc.

In such a presentation, there are cases to repeatedly conduct presentations with the identical content. For example, there are cases to conduct the presentation once done at a certain city, at another city, or the presentation once conducted in a certain conference, again in another conference.

In such a cases conducting a presentation with the identical content every time is troublesome, which imposes a heavier burden on the presenter (explainer). As a way to cope with the problem, there is a method to reutilize a videotaping of the scene a presentation is being conducted.

However, there is a problem that a videotaped content displayed on the screen or the like is not easy to view the image thereof while the simultaneous recording of a voice is difficult to hear.

In order to conduct a presentation more efficiently, it is frequently desired to partially change the presentation first made, in its explanations, materials presented or presentation timing of the materials.

However, in the method of re-utilizing a videotaping, it is not easy to partially change the content of a presentation. It is naturally possible to make newly a partial presentation, videotape it, edit a videotaped content with utilizing an image content, and produce new presentation-taped video software. However, editing is troublesome and not a technique easy to utilize.

### SUMMARY OF THE INVENTION

An object of an illustrative, non-limiting embodiment of the invention is to provide an art capable of effectively re-utilize the content of a presentation and, further, of easily editing the presentation content.

A content-producing device according to an embodiment of the invention includes: a storage unit that stores content data; and a data reading unit that reads out the content data out from the storage unit; the content data including real-time data containing image and/or voice data output from an output device.

The output device refers to a device capable of outputting an image or a voice. In the specification, the “output device” is sometimes referred to as “image/voice output device”. The image/voice output device may be a material-presenting device or a computer. The material-presenting device refers to an apparatus having a function to store an image, and to output an image by explainer's operation. By using the material-presenting device, the explainer is allowed to output an image in desired timing and display the image by use of a projector or a suitable display, whereby he/she can conduct a technique to make an explanation while referring to the image.

The computer is not limitative in its form but may be, say, a personal computer capable of outputting image and voice signals. The personal computer may be in a configuration having a function to perform the similar function to the material-presenting device by means of exclusive application software.

The content data refers to data concerning a content to be conveyed to the opposite of communication (e.g. person who is to be educated, if for education). The content includes educations (e.g. image and voice information for audiovisual teaching), explanations of product manuals, etc., explanations of rules, reports, various announcements (e.g. announcements at academic society and conferences), and entertainments.

The real-time data of image and/or voice data refers to raw data to be output in real time from the image/voice output device. For example, provided that a presentation is made for 15 minutes by using the image/voice output device, the data refers to an image and voice signal itself output for 15 minutes from the image/voice output device. Accordingly, by directly recording the image/voice data output for 15 minutes from the image/voice output device and reproducing it, reproduced is an image/voice of for 15 minutes.

From now on, image raw data is referred to as real-time image data while voice raw data is as real-time voice data. Meanwhile, the signal for transmitting real-time image data is referred to as a real-time image signal while the signal for transmitting real-time voice data is as a real-time voice signal.

Meanwhile, the image real-time data, to be forwarded to an image display, may be one or a plurality of still images or a moving image. Alternatively, it may be still and moving images that are to be switched over in desired timing.

Incidentally, voice may include music and various ones of sound used in a presentation besides explainer's explanatory voice. The sound of this kind includes various ones of sound helpful in confirming an acoustic characteristic where in an acoustic seminar, various noises where in a seminar concerning noise, bird songs where in a seminar related to wild birds, and so on.

According to a content-producing device of an embodiment of the invention, the content including an image and voice is stored in real time as it is in the storage unit. For example, where the invention is utilized in the application of presentation, by utilizing the content data read out of the storage unit, a presentation identical in the content can be reproduced even in different time and place by the use of an image display and suitable audio/visual equipment.

The presentation reproduced has a content that is not a videotaping of an image projected on a screen nor a recording of a voice, issued at a presentation site, picked up by a microphone. Namely, it is not of an image taken which image once displayed nor a recording of sound once output through a speaker. Accordingly, there is no possibility of occurrence of a trouble that an image, as generated by use of a videotaping, is not easy to see or a voice is not easy to hear.

A content-producing device of an embodiment of the invention, preferably, further including a editing unit that edits the image data and/or the voice data, wherein, in an editing by the editing unit, the content data read out of the storage unit is forwarded to the image/voice output device, the content data sent to the image/voice output device being reproduced by using the image/voice output device, the content data reproduced being inputted to the editing unit where subjected to the editing simultaneously with the reproduction, the editing being controlled according to a control signal sent from the image/voice output device.

According to this aspect, by operating the image/voice output device, the content stored in the storage unit can be reproduced. Simultaneously, by make various editions, a secondary content obtained by the editions can be stored as separate data in the storage unit. Due to this, the content can be revised or so easily.

According to this aspect, editing can be controlled according to a control signal sent from the image/voice output device. For example, where a material-presenting device is used as the image/voice output device, content editing can be made by again making a presentation using the material-presenting device, as in an exemplification referred later. This makes it possible to make an editing easily and efficiently without the need to separately prepare an especial editorial device and to separately perform an editorial operation. This is true for the case where a personal computer is used as the image/voice output device.

Editing includes content division, partial addition to a content, partial deletion from a content, partial replacement (modification) of a content, and a combination of those. Meanwhile, the content-producing device in the invention has a function of reverse play back, pause, pause cancellation, fast forward, fast reverse, image/voice slow forward, image-frame forward and reverse, etc.

In the above configuration, the content data edited is preferably stored in the storage unit simultaneously with the editing. According to this aspect, editing can be made simultaneously with reproduction, to store the result of editing as a secondary content. By using this structure, a content can be easily produced which is partially revised in content.

In the above configuration, a unique index number is preferably given to the content data edited. According to this aspect, an index, for reading out the secondary content, is provided to the secondary content simultaneously with producing and recording of the secondary content. This facilitates to read a secondary content. For example, by associating the index with a barcode, it is possible to realize a configuration to read out a secondary content by a simple operation.

In the above configuration, the image data and/or voice data, output from the image/voice output device, preferably includes an image and voice of an explanation using the image/voice output device.

A content-producing device of an embodiment of the invention may comprise an output port that outputs the content data onto a network, or an output port that outputs the content data to an external memory.

In a content-producing device of an embodiment of the invention, the storage unit may be a hard disk device, the hard disk device be removable.

In a content-producing device of an embodiment of the invention, the content data may include pointing data due to a pointing device and/or path data due to a pen input device.

The pointing device refers to hardware that controls the display position of a point image (e.g. arrow) that points a figure, table or the like. The pointing data refers to data of a point image. The pen input device refers to a pen-type device capable of inputting a marking or writing directly to an image, e.g. light pen. The path input data refers to image data indicative of a path inputted from pen-input data.

An embodiment of the invention can be grasped as an image/voice output device having a structure incorporating or removable of the content-producing device described above. For example, by making the content-producing device as a unit structure and configuring it fittable to a function-extension slot provided on the image/voice output device, it is possible to obtain an image/voice output device having a content-producing function. For example, it is possible to obtain a material-presenting device or personal computer having a content-producing function, referred later.

An embodiment of the invention can be grasped as a computer-readable medium including a set of instructions that controls to produce a presentation content. The instructions includes: a step of reading out content data stored in a storage device; and a step of editing the content data read out; wherein, in the editing step, the content data read out of the storage device is forwarded to the image/voice output device, the content data sent to the image/voice output device being reproduced by using the image/voice output device, the editing being performed simultaneously with reproduction of the reproduced data, the editing being controlled according to a control signal sent from the image/voice output device. A control program corresponding to the set of instructions may be installed in a computer to execute each of the above steps.

The invention can provide a content-producing device capable of effectively re-utilizing an explanatory content of a presentation or the like and, furthermore, of editing the explanatory content in a simple way.

### BRIEF DESCRIPTION OF THE DRAWINGS

FIG. 1 is a concept view showing the outline of a presentation system utilizing an illustrative, non-limiting embodiment of the invention.

FIG. 2 is a block diagram for explaining the function of a material-presenting device.

FIG. 3 is a block diagram explaining the function of a content-producing device utilizing an illustrative, non-limiting embodiment of the invention.

### DETAILED DESCRIPTION OF THE INVENTION

### 1. First Embodiment

(Embodiment Arrangement)

Hereunder, explanation is made on an example that a content-producing device in the invention is applied to a presentation system utilizing a material-presenting device as a video/voice output device.

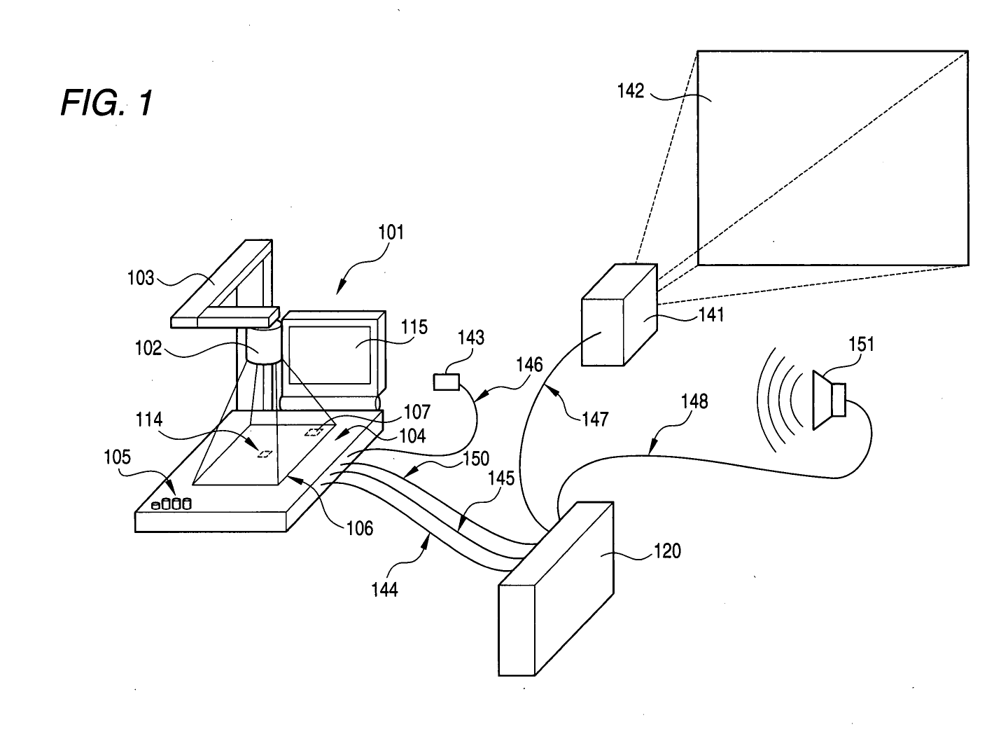

FIG. 1 is a concept figure showing the overview of a presentation system utilizing an exemplary embodiment of the invention. In FIG. 1, there are shown a material-presenting device 101, a content-producing device 120, a projector 141, a screen 142, a microphone 143 and a speaker 151.

The material-presenting device 101 has a function to forward the image of a material prepared (a figure, a graph, table data, a photograph or the like) to the content-producing device 120 and to project it onto the screen 142 through the projector 141. The material-presenting device 101 has also a function to read out a presentation content stored in the content-producing device 120 and to reproduce it through the content-producing device 120. Reproduction is effected by projecting the image of a read-out presentation content onto the screen 142 through the projector 141 while outputting, with magnification, the voice related to the read-out presentation content through the speaker 151. The material-presenting device 101 has operating unit (control switch group 105) for editing the presentation content stored in the content-producing device 120.

The content-producing device 120 has functions to record, as presentation-content data, the details of a presentation conducted by using the material-presenting device 101, and to edit the presentation-content data depending upon a control signal sent from the material-presenting device 101.

The projector 141 is an image display, generally called a projector, which has a function to project an image, based on an inputted image signal, onto the screen or the like thus displaying an image thereon. As for the projector, there are known a three-tube projector and a liquid-crystal projector. The screen 142 is an exclusive screen to form an image projected from the image projector 141. The speaker 151 incorporates an amplifier so that an analog-voice signal, when inputted in a suitable level, can be amplified and output, with magnification, at a desired sound pressure.

In place of the projector 141, it is possible to use a liquid-crystal display, a plasma display or the like. Where the arrangement is for personal use, a small-sized liquid-crystal display or the like can be used in place of the projector 14.

The microphone 143 has an output to be inputted to the material-presenting device 101 through an voice-signal transmission cable 146. Meanwhile, the material-presenting device 101 and the content-producing device 120 are connected together by an image-data-signal transmission cable 144, a voice-signal transmission cable 145 and a USB (universal serial bus) cable 150.

The image-data-signal transmission cable 144 is a transmission cable to transmit an analog real-time image signal from the material-presenting device 101 to the content-producing device 120. The voice-signal transmission cable 145 is a transmission cable to send an analog real-time voice signal from the material-presenting device 101 to the content-producing device 120. The USB cable 150 is a signal cable to send a control signal of upon editing from the material-presenting device 101 to the content-producing device 120, and content data (image and voice data) reads out of a storage unit (hard disk drive 125, referred later) to the material-presenting device 101.

Meanwhile, the content-producing device 120 is connected with the projector 141 through the image-signal transmission cable 147, and with a speaker 151 through a speaker cable 148.

The material-presenting device 101 has an imager device 102, an arm 103, a material base 104, a control switch group 105, a material-unique-data reader 107, a rest detector 114 and a display 115. In FIG. 1, there is shown a state that an arbitrary material 106 is put upon the material base 104.

The imager device 102 is a CCD camera to take an image of a material 106 put upon the material base 104. The control switch group 105 is arranged with an imaging switch to determine the timing the imager device 102 takes an image and a switch group allowing to edit a presentation content, referred later.

The material-unique-data reader 107 has a function to read out a barcode seal (or barcode print) affixed on a material 106. The rest detector 114 is an optical sensor to detect a fact that a material 106 is put upon the material base 104.

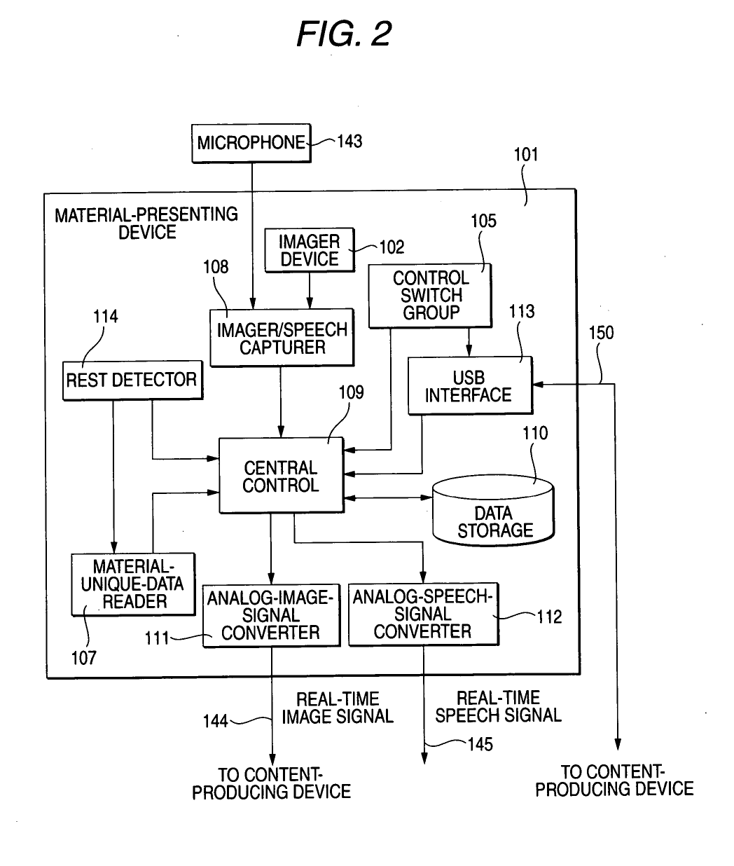

FIG. 2 is a block diagram explaining the function of the material-presenting device 101 shown in FIG. 1. As shown in FIG. 2, the material-presenting device 101 has an image capturer 108, a central control 109, a data storage 110, an analog-image-signal converter 111, an analog-voice-signal converter 112 and a USB interface 113, besides the constitutional elements described above.

The image/voice capturer 108 is to fetch an image signal taken by the imager device 102 and forward it to the central control 109. The central control 109 is to write (stores) image data to the data storage 110 and read out the image data stored in the data storage 110. The central control 109 is to forward, to the analog-image-signal converter 111, the image signal sent from the image/voice capturer 108, the image signal read out of the data storage 110 or the image signal sent from the USB interface 113. The central control 109 is to forward the image signal sent from the image/voice capturer 108 and USB interface 113 to the analog-voice-signal converter 112.

The analog-image-signal converter 111 is to convert the image signal sent from the central control 109 into an analog signal (e.g. analog RGB signal) and forward it to the content-producing device 120 (see FIG. 1). The analog-voice-signal converter 112 is to convert the voice signal sent from the central control 109 into an analog signal (e.g. analog voice signal) and forward it to the content-producing device 120.

The microphone 143 is to pick up an explanatory voice of the explainer (person who is making a presentation) when conducting a presentation by use of the material-presenting device 101 and convert it into an electric signal. Usually, the microphone 143 is used fixed at the breast, etc. of the explainer. The voice output from the microphone 143 is fetched to the image/voice capturer 108.

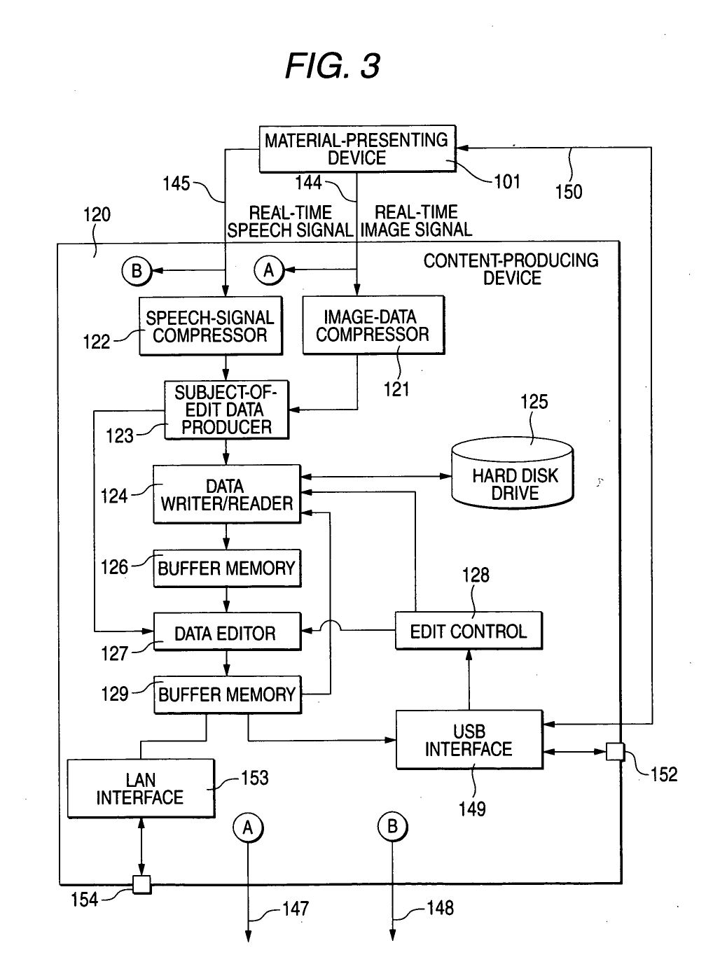

FIG. 3 is a block diagram explaining the function of the FIG. 1 content-producing device 120 the content-producing device 120 has an image-data compressor 121, a voice-data compressor 122, a subject-of-edit data producer 123, a data writer/reader 124, a hard disk drive 125, a buffer memory 126, a data editor 127, an edit control 128, a buffer memory 129, a USB interface 149 and a LAN (local area network) interface 153.

The image-signal compressor 121 is to digitize the image-signal data sent from the material-presenting device 101 and data-compress it. The voice-signal compressor 122 is to digitize the voice signal sent from the material-presenting device 101 and data-compress it. The subject-of-edit data producer 123 associates between the compressed ones of image and voice data and produces presentation-content data. The presentation-content data is an example of content data in the invention.

The data writer/reader 124 has functions to write presentation-content data to the hard disk drive 125 and to read presentation-content data out of the hard disk drive 125. The hard disk drive 125, corresponding to a storage unit in the invention, is to store presentation-content data therein.

The buffer memory 126 has a function to temporarily store and buffer the presentation-content data sent from the data writer/reader 124. The data editor 127 is to perform an editing, such as data division, new data interrupt or partial data erase, of the presentation-content data temporarily stored in the buffer memory 126. Those editing details will be exemplified later.

The edit control 128 is to control the data editor 127 to execute the editing as instructed by operating the switch group 105 of the material-presenting device 101.

The buffer memory 129 has a buffer function to temporarily store the presentation-content data edited or not edited in the data editor 127.

The USB interface 149 has a function to receive, from the buffer memory 129, the presentation-content data read out of the hard disk drive 125 and forward it to the material-presenting device 101 by a conversion into a USB-standard signal. The USB interface 149 is to receive a control signal under USB-standard from the material-presenting device 101 and convey the control content thereof to the edit control 128. The USB interface 149 has a USB-connection terminal to connect a device other than the material-presenting device 101. The LAN interface 153 is an interface enabling to connect the content-producing device 120 to a LAN of a predetermined standard. Connection to a LAN is through the LAN-connection terminal 154.

(Embodiment Operation: Operation in the First Presentation)

First explained is a presentation with using the material-presenting device 101. Before conducting a presentation, the image of a material to display on the screen 142 is registered in the material-presenting device 101.

For example, there are assumed ten material sheets for a presentation to conduct. In this case, the ten material sheets are put, one by one, on the material base 104 of the material-presenting device 101. Those are taken images of by the imager device 102, to store the respective material images in the data storage 110 (see FIG. 2) of the material-presenting device 101.

Namely, the materials are put on the material base 104, and the materials thus rested are taken images of by operating the control switch group 105. The material images thus taken, in the imager device 102, are converted into image signals. The image signals are fetched in the image capturer 108 and then forwarded to the central control 109.

Incidentally, the material rested, at its corner, is affixed or printed with a barcode indicative of unique information for identifying the material. Simultaneously with the imaging, the barcode is read out by the material-unique-data reader 107. In the central control 109, the unique information thus read is associated with the captured image data. The image data, associated with the unique information read out of the barcode, is stored in the data storage 110. This operation is carried out for each of the materials prepared.

When conducting a presentation, the explainer (or his/her assistant) puts the materials, desired to display on the screen 142, onto the material base 104, in progress with the presentation. When the material is put on, the fact the material is rested is detected by the function of the rest detector 114, allowing the material-unique-data reader 107 to read out the barcode on the material.

The central control 109 retrieves the data storage 110 depending upon the code of the barcode read out, to thereby read out the corresponding image data. The image data read out is forwarded to the analog-image-signal converter 111 and further sent therefrom to the content-producing device 141. The image signal is forwarded through the content-producing device 120 to the projector 141, and then projected onto the screen 142 from the projector.

Namely, in case a material previously registered is put on the material base 104 in timing of progress with the presentation, the image of the material is read out of the data storage 110 and forwarded through the content-producing device 120 to the projector 141 where projected onto the screen 142.

On this occasion, the image displayed on the screen 142 is stored in real time as a real-time image directly into the content-producing device 120. Meanwhile, the explanatory voice corresponding to the real-time image is associated with the real-time image and stored in the content-producing device 120. Namely, simultaneously with the presentation, presentation-content data is stored in the content-producing device 120. The presentation-content data in the first presentation is prepared as primary data (primary content) to be subjected to editing, referred later.

For example, it is assumed that the presentation is conducted for 10 minutes wherein ten material sheets are displayed by projection onto the screen 142 for 10 minutes in time with the presentation. In this case, when reproducing the images of the presentation-content data stored in the content-producing device 120, the ten sheets of images can be reproduced on the screen 142 in completely the same timing as the presentation. Namely, the images presented at the presentation are similarly reproduced as they are with the passage of time. This is true for the voice data contained in the presentation-content data.

In the above operation, the following processing is effected in the content-producing device 120. First, in progress with a presentation, the image signal (real-time image signal) is sent in real-time from the material-presenting device 101 through the image-signal transmission cable 144, which is branched, i.e. one is bypassed to the image-signal transmission cable 147 while the other is fetched to the image-data compressor 121.

The real-time image signal, bypassed to the image-signal transmission cable 147, is forwarded to the projector 14 where the projector 141 projects it directly onto the screen. Due to this, in the case a material 106 is put on the material base 104 of the material-presenting device 101, the image thereof is displayed on the screen 142.

On the other hand, the real-time image signal fetched in the image-data compressor 121 is converted there into a digital signal and subjected to data-compression processing.

The voice, detected by the microphone 143, is fetched from the image/voice capturer 108 into the material-presenting device 101 and, further taken into the voice-data compressor 122 of the content-producing device 120 by way of the central control 109 and the analog-voice-signal converter 112.

Meanwhile, the voice signal (real-time voice signal), taken in the content-producing device 120, is bypassed to the speaker cable 148 and then broadcast in the form of a sound wave into a presentation hall through the speaker 151. This outputs explainer's voice, such as comments, in real-time into the presentation hall.

Meanwhile, the real-time voice signal, taken in the voice-signal compressor 122, is converted there into a digital signal and, further, subjected to data-compression processing.

The real-time image and voice signals, data-compressed, are associated together in the edit-data producer 123, to produce primary data concerning the presentation content.

The presentation-content primary data is written from the data writer/reader 124 to the hard disk drive 125. In this manner, the image data, projected to the screen 142 during the presentation, is prepared as real-time image data directly recorded while the voice data synchronous therewith is stored in the hard disk drive 125.

Namely, simultaneously with a presentation while presenting a material onto the screen 142 by use of the material-presenting device 101, stored as electronic data (presentation-content data) are the image real-time content (real-time image) displayed on the screen 142 and the explainer's comments (real-time voice) synchronous therewith, in the content-producing device 120. On this occasion, a predetermined index (identification mark) is provided to the presentation-content data stored.

(Embodiment Operation: Operation in Editing)

Now explained is an example where to edit the presentation-content primary data stored in the content-producing device 120.

(Divisional Editing Example)

Explained here is a divisional editing example that a presentation is for, say, a lecture on the operation procedure at a factory production site wherein the lecture is conducted with two divisional lectures. First obtained is a state the content data of presentation is stored in the content-producing device 120. This can be obtained by once performing the presentation by use of the material-presenting device 101.

Then, reproduced is the presentation-content data stored in the content-producing device 120. By the reproduction, the image presented at the first presentation is displayed to the screen 142 in the same timing as that. Simultaneously, the speaker 151 outputs an explanatory voice utilizing the image being displayed. Namely, the first presentation is reproduced.

The person who is making an editing operates the control switch group 105 in proper timing of pauses in the lecture being reproduced, and suspends the reproduction at a predetermined portion thereof. The content reproduced so far is stored, as a folder of one data, in the content-producing device 120.

Then, the reproduction is resumed at the portion suspended. After completing the reproduction, the content reproduced at the resumption and subsequent is stored, as a folder of another data, in the content-producing device 120.

This makes it possible to divide, into two, the presentation-image and explanatory-voice real-time data concerning the lecture for a continuous predetermined time, thus obtaining presentation contents twice in time.

In this case, index numbers are provided to the two contents obtained by the division. By using the index numbers, a predetermined content can be selectively reproduced by simple operation.

(Processing in Divisional Editing)

Now explained is an example of a processing to be made in the content-producing device 120 during a divisional editing.

At first, when operating the control switch group 105 thereby instructing to reproduce the primary data of presentation content, a control signal thereof is forwarded to the content-producing device 120 through the USB cable 150. The content-producing device 120 receives it at the USB interface and forwards it to the edit control 128.

The edit control 128, received the signal instructing for reproduction, forwards a control signal to the data writer/reader 124. The data writer/reader 124, in turn, reads predetermined presentation-content data out of the hard disk drive 125. The presentation-content data read out is forwarded to the buffer memory 126 where it is sent to the data editor 127 after buffering.

Unless there is a divisional editing operation, the presentation-content data read out is forwarded from the data editor 127 to the buffer memory 129. The presentation-content data once stored in the buffer memory 129 is forwarded to the USB interface 149.

The presentation-content data, sent to the USB interface 149, is converted into USB-standard signal and forwarded to the material-presenting device 101. The presentation-content data, sent to the material-presenting device 101, is taken in the USB interface 113 and forwarded therefrom to the central control 109. The image data contained therein is converted into an analog image signal, in the analog-image-signal converter 111. The voice data is forwarded to the analog-voice-signal converter 112 where it is converted into an analog-voice signal.

The analog-image signal converted is forwarded as a real-time image signal to the content-producing device 120, and then sent to the projector 141 therefrom. Meanwhile, the analog-voice signal converted is forwarded as a real-time voice signal to the content-producing device 120, and then sent to the speaker 151 therefrom.

Unless there is an editing operation (divisional editing operation, in this case), the presentation-content data read out of the hard disk drive 125 is reproduced as it is by use of the projector 141 and the speaker 151.

Namely, where divisional editing is not done, the presentation-content primary content stored in the hard disk drive 125 is displayed in the same timing as the first presentation. Simultaneously, the speaker outputs an explanatory voice related to that. Namely, the presentation is reproduced in real time.

In the course of reproducing the presentation, when a divisional editing is instructed by operating the control switch 105 of the material-presenting device 101, a control signal thereof is output from the edit control 128 to the data editor 127.

The data editor 127 operates 127 under such control, to separate from the buffer memory 126 the presentation-content data to be sent to the buffer memory 129, in predetermined timing. Those two of data separated are both prepared as presentation-content secondary data.

In this manner, by making a divisional editing on the presentation-content data, two presentation contents can be obtained.

(Partial Editing Example)

Explanation is made on an example to add a new content to a part of the presentation content being stored in real time. Explanation here is on an example where a second presentation is conducted by utilizing the primary data wherein editing is made simultaneously with the presentation.

First, obtained is a state that the content-producing device 120 is stored therein with presentation-content data to be prepared as primary data. This can be obtained by once conducting first the usual presentation. Then, the presentation (second presentation) is again made while reproducing the content stored in the content-producing device 120.

When the reproducing comes a point requiring a modification, the point is suspended from reproducing. If necessary, the material is put on the material base 104, to again conduct a presentation on that point again. Namely, the reproduction is suspended in the course thereof, to make a changeover to the actual presentation at the site.

When completing the partial re-doing of the presentation, the primary data is resumed to reproduce. In this manner, a modified version of presentation-content data (secondary data) can be obtained by adding a partial presentation to a desired point.

Incidentally, where an unwanted portion arises due to a new addition of a presentation content, it is satisfactory to make a delete process by operating the control switch group 105 while doing a fast-forward reproduction.

The method described, if used, enables a partial modification or addition to the presentation content. This can greatly reduce the effort or burden in obtaining a presentation content. Namely, by making again the presentation utilizing the primary content by utilization of the function of the material-presenting device 101, a secondary content can be easily obtained. In this case, because editing can be by operating the material-presenting device 101, the editing is not troublesome wherein extra operations are not required in editing. This is important in conveniently utilizing the system.

Meanwhile, by repeating the presentation twice and trice, quality is improved gradually. Thus, a highly complete presentation content can be produced while repeating the presentation.

The presentation content is easy to copy because it is of electronic data. It can be effectively used in such a case where to simultaneously conduct quality presentations at a plurality of sites.

(Processing for Partial Editing)

Explanation is made on the processing to be effected in the content-producing device 120 during the partial editing.

When the control switch group 105 of the material-presenting device 101 is operated to issue an instruction for reading presentation-content data out of the hard disk drive 125, a signal thereof is output from the edit control 128 of the content-producing device 120 to the data writer/reader 124. Due to this, predetermined presentation-content data is read out of the hard disk drive 125.

The presentation-content data read out of the hard disk drive 125 is buffered in the buffer memory 12. By way of the similar route to the foregoing, an image is projected from the projector 141 onto the screen 142 while voice is output, with magnification, through the speaker.

When it comes the timing to reproduce a partial-editing-required point in the course of a reproduction, the explainer (person who is making an editing) operates the control switch group 105. Thereupon, the data editor 127 suspends the reading of primary-data out of the buffer memory 126.

In this state, re-explanation using the microphone 143 and/or material-presenting operation using the material-presenting device 101 are carried out suitably. For example, when a new material is selected, the image signal thereof is forwarded from the material-presenting device 101 to the content presenter 120, which is sent to the image-data compressor 121, the subject-of-edit data producer 123 and the data editor 127. Meanwhile, the explanatory voice, to be made in time with the presentation of the image, is detected by the microphone 143. The output of the microphone 143 is forwarded from the material-presenting device 101 to the content-producing device 120, and further from the voice data compressor 122 to the subject-of-edit data producer 123.

In the subject-of-edit data producer 123, association is made between the image-data real-time signal and the voice-data real-time signal, thereby producing a new presentation-content data. The presentation-content data is forwarded to the data editor 127 where it is inserted to a suspension point of the presentation-content data (primary data).

Namely, the content of the re-presentation is joined to the presentation-content data being reproduced to a part of the course. The presentation-content data joined with the new content is forwarded from the data editor 127 to the buffer memory 129 where it is stored. It is then returned from the USB interface 149 to the material-presenting device 101 where it is again inputted as a real-time image signal and real-time voice signal to the content-producing device 120.

When completed the partial presentation corresponding to the partial modification content, the part earlier suspended from reproduction and subsequent is continued to reproduce.

In this manner, presentation is made as to the content partially inserted with a new content. The new content, because buffered in the buffer memory 129, is forwarded to the data writer/reader 124 and then written to the hard disk drive 125.

By doing so, stored in the hard disk drive 125 is the presentation-content secondary data that the new content is partially added to the presentation-content primary data. Namely, by editing the primary content simultaneously with the reproduction thereof, a secondary content edited can be obtained.

Where a partial content is deleted separately from a partial addition to the presentation-content data, the following process is done. In this case, an instruction signal for deletion is forwarded from the material-presenting device 101 to the content-producing device 120 in the course of reproducing the presentation-content data. In response, the data editor 127 generates presentation-content data (secondary data) deleted of the instructed part, from the presentation-content data sent from the buffer memory 126.

The secondary data is returned from the buffer memory 129 to the data writer/reader 124 where it is stored as a secondary content in the hard disk drive 125. Meanwhile, it is returned from the USB interface 149 to the material-presenting device 101 where it is output as a real-time voice signal and real-time image signal to the content-producing device 120. The content is output from the content-producing device 120 to the projector 141 and speaker 151, thereby making a presentation of the secondary content edited with a partial deletion.

In this manner, it is possible to carry out an editing to delete a part of the presentation once made while reproducing the primary content, by use of the material-presenting device.

(Case with No Editing)

Instead of making an editing, the presentation-content data stored in the hard disk drive 125 may be reproduced as it is. In this case, the presentation once conducted can be played again with no changes. The use of this method allows for conducting the same content of presentations a number of times by reproducing electronic data.

(Material-Presenting Device Other Operation Examples)

The material-presenting device 101 can be used in an orthodox way that a material put on the material base 104 is taken an image by the imager device 102 so that the image taken is forwarded to the projector 141 and projected onto the screen 142. In also this case, real-time image data and real-time voice data can be stored in the content-producing device 120. By editing those, a presentation content can be reproduced.

### 2. Second Embodiment

The material-presenting device and the content-producing device can be structurally integrated together. In this case, there is included a structure that the content-producing device 120 is incorporated in the material-presenting device 101, say, in the structure shown in FIG. 1. Alternatively, the material-presenting device can be structurally arranged removably with the content-producing device. Naturally, the material-presenting device can be removably attached on the content-producing device. This form provides a material-presenting device having a content producing function.

### 3. Third Embodiment

In the content-producing device 120 structure, the hard disk drive 125 may be structured removable. By doing so, it is possible to effectively, efficiently arrange the contents in order and save backup data in the case of handling a multiplicity of contents.

Meanwhile, the content-producing device 120 may be structured having a fixed hard disk device and further a removable hard disk device. Alternatively, in place of the hard disk drive 125, other storage unit (e.g. semiconductor memory) can be used or used together therewith.

Meanwhile, the external small-sized memory (so-called a USB memory), to be connected to the USB terminal, may be provided removable. Such a small-sized memory is convenient in bringing out data or upon backing up data. For example, by connecting a small-sized memory using a flash memory to the USB-connection terminal 152 and transferring data to the small-sized memory, it is easy to bring out data or making a data backup.

### 4. Fourth embodiment

The content-producing device 120 may have an output terminal to a network. The network may be a LAN (local area network). By allowing a connection to the network, it is possible to output a content to the outside of the apparatus through the network or capture a content into the apparatus through the network. FIG. 3 depicts a configuration having the LAN interface 154, as an example thereof

### 5. Fifth Embodiment

The content data, to be handled by the content-producing device 120, can include pointing data due to pointing device and/or path input data due to a pen-input device.

For example, there is a case that, where making a presentation with the material-presenting device 101 by utilization of an image formed on the screen 142, explanation is conducted while indicating at a predetermined area of the image by means of a point image. Here, the point image uses, say, an arrow indication. In this case, the point image can be taken as image data in the content data.

For taking a point image in a content data, there is a method that a predetermined wavelength of light is illuminated by a light pen onto the material base 104 whose illumination point is positionally taken image by the imager device 102 so that it is superimposed as a point image over the image.

Meanwhile, as an art using the similar principle, there is a technique that a light pen is used as a pen input device to write a character, underline or the like onto an image projected on the screen 142. In also this case, it is satisfactory to take, as image data, a path of a written character, underline or the like, into a content data.

### 6. CONCRETE EXAMPLES

### Example 1

Explanation is made on the examples employing the invention in producing a content (operation manual) explaining the product assembling procedure in a factory.

At first, explained is an assembling procedure of a certain product, by use of the FIG. 1 presentation system. This is an explanation for producing a primary content, which explanation is made in the absence of viewers (product-line employees, in this case).

Then, the explained manufacturing processes in series are divided on a part-by-part basis. For example, division is with rough categories, e.g. housing assembling process, control assembling process, a paint process, an inspection process, etc.

Such dividing is performed as follows. First, the material-presenting device 101 is operated to read a primary content out of the content-producing device 120 to the material-presenting device 101. The primary content read out is sent back to the content-producing device 120. The image is projected from the projector 141 while voice is reproduced from the speaker 151.

When the timing of division comes, pushed is a content-divide switch, not shown, of the control switch group 105. Thereupon, the reproduction content of from a reproduction start to suspension is stored, as an electronic file given with a predetermined index, in the hard disk drive 125. In this manner, a second content (−1) can be obtained which covers a start to a certain time point of the primary content.

When the reproduction is continued as it is and the content-divide switch is again pushed at a desired timing, a primary content is clipped which is of from the suspension point to the division timing in this time, thus obtaining a secondary content (−2). The secondary content (−2) is automatically given a unique index and stored in the hard disk drive 125.

In this manner, by dividing in desired timing a primary content while reproducing it, secondary content divided can be produced in plurality. Each of the secondary content is given with a unique index that can be read out later individually.

Because the secondary contents in this structure are easy to modify while reproducing thereof, the assembling procedure, if changed or modified, can be easily coped with. Meanwhile, because unique indexes are provided respectively to the divided secondary contents, the employees can be explained (based on images and voices) at a required time as to the assembling procedure for a required point.

For example, by size-reducing the FIG. 1 system and using such a system that a reproduction content can be viewed on the usually display, the employees are allowed to confirm a product assembling procedure by themselves.

In this case, by assigning barcodes to the manufacturing processes and associating those with the indexes, assembling-procedure confirming operation can be made swiftly and easily at the manufacturing site. Where the assembling procedure is desired to confirm, it is not preferred to repeatedly read a thick manual or make a retrieval using a computer terminal because of troublesomeness in operation. However, the use of the system relieves the troublesomeness.

Meanwhile, in the exemplified case, a product version upgrading or specification change if occur can be coped with speedily. Namely, in the case to producing a new product improved over the existing product, improvement is mostly such a partial component replacement or partial exchange of ROM into an addition of new function or an improvement in function.

In such a case, a secondary content can be produced corresponding to a new product, by use of the primary content explaining the first assembling procedure. For example, by changing a partial explanation on a new product into an explanation using a new figure to thereby add a new content, explanation is possible as to a new product assembling procedure. By doing so, it is possible to swiftly produce an explanatory content of a new product assembling procedure. On this occasion, because necessary operation steps are satisfactorily read out, the effort required in revision can be saved. Because modification can be made by operating the material-presenting device 101 while reproducing the content, it is possible to produce a secondary content which is revised effortlessly while effectively utilizing the basic content.

Meanwhile, where there are a plurality of production lines or there are a number of persons engaged in production, it is often the case to hold explanatory meetings a plurality of times. In such a case, the burden on the explainer can be relieved by re-using the content memorizing the content explained the first. When pursuing a plurality of explanatory meetings, partial modification can be easily made.

Meanwhile, the invention can be employed in explaining the assembling procedure of a product having versions partially different in function. In this case, by first producing a content explaining the basic assembling procedure and editing it, an explanatory content can be produced for an assembling procedure corresponding each of the version.

On this occasion, while making an explanation using the FIG. 1 system, explanatory contents can be produced in order for the respective assembling procedures as to the versions. Namely, simultaneously with explaining the assembling procedure of the version, an explanatory content thereof can be produced. In this manner, it is possible to provide quality explanations and, at the same time, to relieve the effort in producing explanatory materials or the burden on the explainer during explanation.

### Example 2

Explanation is made on the case that the invention is utilized in producing a product instruction manual. Explained here is an example that a manual is produced with images and voices. In this case, using the FIG. 1 system, explanation is made while projecting an image onto the screen 142, thereby producing a primary content.

While reproducing the primary contents with using the material-presenting device 101, a revised version (secondary content) of the manual can be produced by replacing (or deleting) the required portion of images and voices. This operation can be made while reproducing the primary content using images and voices, and hence can be effectively done with less effort.

By means of the similar approach, it is easy to produce an instruction manual for a product having upward or downward models similar in basic construction or function. For example, first prepared is an instruction manual as to a downward model. Then, it is reproduced on the FIG. 1 system wherein, while projecting an image on the screen 142, editing is simultaneously made by reproducing explanatory voices. On this occasion, by adding or replacing explanatory texts, figures, etc. required for the upward model, an instruction manual for the upward model can be produced.

The technique explained here can be made use of in producing instruction manuals, various texts, various guidance manuals, etc. for machine tools.

### Example 3

In a school education class, there are cases to conduct the same lesson in a plurality of classes. For example, a teacher, who is in charge of three classes, is to teach the same education content for the three classes. In such a case, the FIG. 1 presentation system, if used, allows for conducting a lesson more effectively and efficiently. This is exemplified in the below.

At first, in a lesson for the first class, audiovisual education is conducted with using the material-presenting device 101. In this case, the material, etc. of a lesson content is displayed on the screen 142, and the teacher conducts a lesson while pointing the same. In this case, the images projected on the screen 142 are inputted as real-time image data into the content-producing device 120. Teacher's oral explanations are detected by the microphone 142, and the real-time voices are inputted to the content-producing device 120. The real-time image data and the real-time voice data are associated together and stored as lesson content in the content-producing device 120.

When the lesson content is reproduced, reproduced is the same content as that of the lesson. Namely, materials are presented on the screen 142 whose explanatory voices are reproduced, similarly to the lesson first done. For example, in a lesson for the second class, the same lesson can be taught by reproducing the lesson content conducted for the first class.

In this case, by modifying the lesson content while conducting the second lesson, it is possible to obtain a lesson content enhanced in quality furthermore. Explanation is made on an example to conduct the second lesson by using the FIG. 1 system. At first, the teacher operates the material-presenting device 101, to retrieve a lesson content memorizing the first lesson. For example, displayed on the display 115 is a list of indexes that are stored in the content-producing device 120. From those, selected is a lesson content (lesson content 1) obtained as a result of the first lesson.

After selected lesson content 1, operation is made to reproduce it. This operation is made by operating the control switch group 105. On this occasion, content data concerning lesson content 1 is read out of the hard disk drive 125 of the content-producing device 120. The data is forwarded to the material-presenting device 101 through the USB cable 150. The material-presenting device 101 forwards the content data sent from the content-producing device 120, as a real-time image signal and real-time voice signal, back to the content-producing device 120.

The content data concerning lesson content 1, sent to the content-producing device 120, is stored as a separate file from lesson content 1 as lesson content 2, in the hard disk drive 125. The real-time image signal, contained in the content data of lesson content 1, is forwarded from the content-producing device 120 to the projector 141. Meanwhile, the real-time voice signal is forwarded to the speaker 151. Thus, reproduced is the same content as the first lesson.

It is herein assumed that the teacher thinks the first lesson is insufficient in explaining a certain portion and desires to re-explain it. In this case, when the reproduction timing thereof comes, the teacher operates the operation switch group 105 to suspend the voice reproduction. In this case, because image reproduction continues as it is despite suspending the voice reproduction, the teacher is allowed to add new explanations while viewing the image.

The new explanations are detected by the microphone 143 and forwarded from the material-presenting device 101 to the content-producing device 120. The real-time voice signal as to the new explanation is associated with the real-time image signal of an image displayed on the screen 142, and stored as a continuation to lesson content 2 in the hard disk drive 125. Meanwhile, the image of lesson content 2 is projected to the screen 142. Simultaneously, the explanatory voice is reproduced in real time from the speaker 151.

After completing the re-explanation, voice reproduction suspension is cancelled in timing with displaying an image projected on the screen. This restores to reproduce the voice of lesson content 1. On this occasion, reproduced is the voice in a content in timing with the image projected to the screen.

In this manner, while conducting the second lesson due to reproducing the primary content, a lesson can be simultaneously conducted to add a partial modification to the primary content. Meanwhile, the content of the second lesson is stored as a secondary content in the hard disk device, which can be utilized similarly to the primary content.

The use of this technique can relieve the burden on the teacher when he/she conducts a lesson for a plurality of classes.

The technique can be utilized for the lessons of subjects that classes are organized on an achievement-degree basis. Explanation is made below on an example that the technique is applied to mathematical lessons that classes are organized on an achievement-degree basis, e.g. basic course, application course and development course.

At first, a lesson concerning a basic content is done, which is provided as a primary content. Then, a lesson is conducted while reproducing the primary content, to produce a secondary content added with the explanations as to middle-level solutions and practical questions. Furthermore, a lesson is done using the secondary content, to produce a tertiary content added with the explanations as to higher-level solutions and practical questions. In this manner, the primary content for basic course, the secondary content for application course and the tertiary content for development course can be produced efficiently.

The invention can be utilized for lecture meetings, seminars and various lessons. Meanwhile, the invention can be utilized for producing texts and instruction manuals.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-40865, filed Feb. 17 of 2005, the contents of which is incorporated herein by reference.

What is claimed is:

1. A content-producing device comprising:
a storage unit that stores content data; and
a data reading unit that reads out the content data from the storage unit,
wherein the content data comprises real-time data including at least one of image data and voice data output from an output device.

2. The content-producing device according to claim 1, wherein the output device comprises at least one of a material-presenting device and a computer.

3. The content-producing device according to claim 1, further comprising an editing unit that performs an editing of the content data,
wherein the content data is simultaneously reproduced at the output device and is edited at the editing unit, and
the editing is controlled according to a control signal from the output device.

4. The content-producing device according to claim 3, wherein the content data is stored in the storage unit simultaneously with the editing.

5. The content-producing device according to claim 4, wherein a unique index number is given to the content data stored in the storage unit.

6. The content-producing device according to claim 1, wherein at least one of image data and voice data output from the output device is received as the content data.

7. The content-producing device according to claim 1, comprising an output port that outputs the content data to at least one of a network and an external memory.

8. The content-producing device according to claim 1, wherein the storage unit comprises a hard disk device, the hard disk device being removable.

9. The content-producing device according to claim 1, wherein the content data comprises at least one of pointing data due to a pointing device and path data due to a pen input device.

10. An output device comprising a content-producing device according to claim 1, the content-producing device being incorporated in or removable from the output device.

11. A computer-readable medium including a set of instructions comprising:
reading out content data stored in a storage device;
forwarding the content data to an output device;
reproducing the content data in the output device; and
editing the content data;
wherein the editing is performed simultaneously with the reproducing, and the editing is controlled according to a control signal from the output device.
